(19) United States
(12) Patent Application Publication
(10) Pub. No.: US 2016/0325995 A1
(43) Pub. Date: Nov. 10, 2016

(54) Safety Helium, Blending Oxygen of 15 to 30% into Helium to make a safe gas for filling balloons

(71) Applicant: John Joseph Mayeux, Hanover Park, IL (US)

(72) Inventor: John Joseph Mayeux, Hanover Park, IL (US)

(21) Appl. No.: 14/707,666

(22) Filed: May 8, 2015

(51) Int. Cl. C01B 23/00

(52) U.S. Cl. CPC C01B 23/00

(57) ABSTRACT

Introducing and blending sufficient Oxygen (greater than 15%) to publicly sold Helium tanks used to fill novelty balloons could reduce the potential Oxygen deprivation during intentional Inhalation or incidental displacement of Air in a concealed space.

This claim differs from existing pure Helium, currently distributed and is supportive of current ruling to label apparatus with indications of potential dangers if inhaled, can cause death.

Another claim is it can reduce consumption of a natural resource, Helium, and potentially reduce cost of product for this use.

This is not a medical mixture and Is Intended only to promote some safety measure.

All Novelty balloons would still lift and may have only a slight diminished holding time, however, existing latex balloon sealants would promote extended float times.

### DRAWING FIGURE DESCRIPTION

FIG. 1 is a perspective view of an exemplary embodiment of the invention

FIG. 2 is a section view of the invention, taken along line 2-2 in FIG. 1

FIG. 3 is a flow chart of the invention

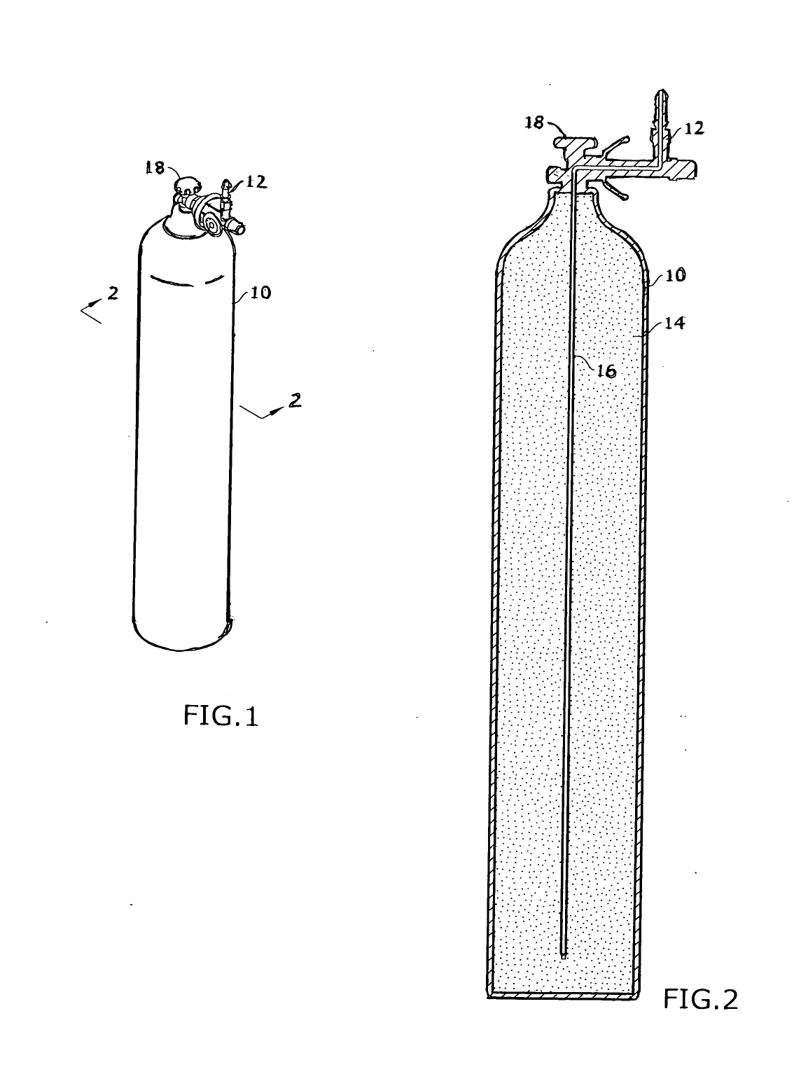

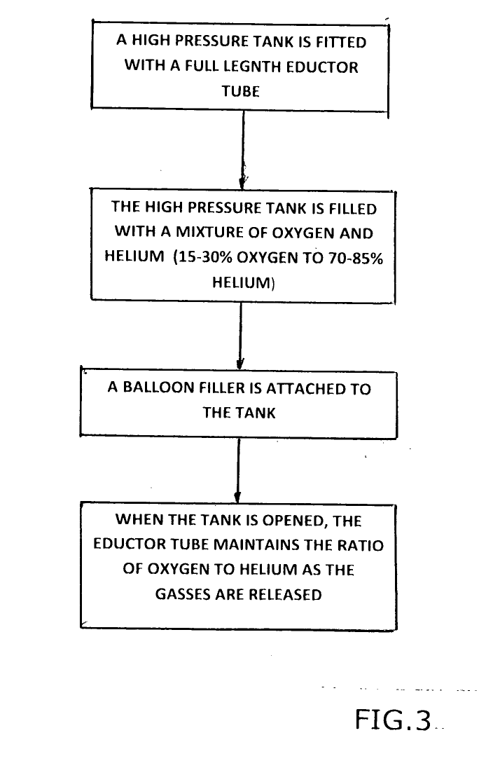

### ITEMIZED PARTS LIST

10 is the exemplary high pressure tank

12 is the exemplary balloon filler

14 is the mixture of oxygen and helium gases

16 is the educator tube

18 is the tank valve handle

### DESCRIPTIVE SPECIFICATION

By adding sufficient Oxygen to Helium it can prevent the flushing of all oxygen from the lungs if inhaled. Helium has warnings of asphyxiation and that it can displace Air. by adding Oxygen to this pure gas may prevent and or reduce this risk. By mixing the components of Part #1,15 to 30% Oxygen, to Part 70 to 85% Helium, we have the resulting relationship.

Part #1 is an oxidizer required to sustain life

Part #2 Helium is inert and is lighter than air, providing lift

By filling both parts #1 and #2 components into a common tank by most commercial methods, gravimetric or pressure temperature the initial mixture may be achieved. If larger High pressure tanks are filled it would be recommended to use an eductor tube to prevent potential stratification that would cause less that even blend ratios during gas withdrawal.

That which is claimed is:

1- New product for target market where the blending of Oxygen not only reduces the dependency of Helium but helps to protect its end users from effects of asphyxiation, dizziness, blacking out, or heart arrest, vs. pure Helium or those blends using Nitrogen or Air used only to reduce product cost.

2- Latex and Mylar novelty Balloons filled with this product may only have a slightly reduced float time because consistent blend ratios are maintained by use of the eductor tube within the tank

3- Prevents displacement of Oxygen in a concealed space and supports the new safety warning labels by doing something about it.
